(19) United States
(12) Patent Application Publication
(10) Pub. No.: US 2013/0136182 A1
(43) Pub. Date: May 30, 2013

(54) MOTION VECTOR REFINING DEVICE AND VIDEO REFINING METHOD THEREOF

(71) Applicant: Zheng-Bin Huang, Kaohsiung City (TW)

(72) Inventor: Zheng-Bin Huang, Kaohsiung City (TW)

(73) Assignee: SUNPLUS TECHNOLOGY CO., LTD., Hsinchu (TW)

(21) Appl. No.: 13/364,337

(22) Filed: Feb. 2, 2012

(30) Foreign Application Priority Data
Nov. 28, 2011 (TW) 100143592

(51) Int. Cl. H04N 7/32; H04N 7/26

(52) U.S. Cl. 375/240.16; 375/E07.125; 375/E07.243

(57) ABSTRACT

A motion vector refining device and a video refining method thereof are provided. The motion vector refining device includes a motion estimation unit, a reliability analysis module and a motion vector mixing module. The motion estimation unit receives a plurality of frames in a video signal or using historical information (for example, motion vectors of closing frames) previously calculated by the motion estimation unit, so as to estimate N target motion vectors. The reliability analysis module analyzes spatial and temporal reliability factors of the N target motion vectors, so as to estimate and adjust N reliability weight values dynamically. The motion vector mixing module uses the reliability weight values to dynamically mix the target motion vectors to produce a refined motion vector. Therefore, the motion vector refining device and a motion interpolation apparatus using the same can avoid instability of a motion vector on an edge of a moving object.

### CROSS-REFERENCE TO RELATED APPLICATION

This application claims the priority benefit of Taiwan application serial no. 100143592, filed on Nov. 28, 2011. The entirety of the above-mentioned patent application is hereby incorporated by reference herein and made a part of this specification.

### BACKGROUND OF THE INVENTION

1. Field of the Invention

The present invention generally relates to a motion interpolation technology, in particular, to a motion vector refining device for dynamically refining a motion vector and a video refining method thereof.

2. Description of Related Art

Currently, manners for displaying a video on a display apparatus may be roughly classified into the interlace mode (usually applied in cathode-ray tube (CRT) television) and the progressive scan mode (usually applied in digital television or films). In the interlace mode, only half of scan lines of a video are transmitted or played each time. That is, odd scan lines (called an odd field) or even scan lines (called an even field) of a frame are played in an interlaced manner. Each frame field only has data of odd scan lines or even scan lines, so that during playing, the video is not continuous in a vertical direction. That is, the resolution of a frame in the vertical direction decreases. In contrast, in the progressive scan mode, scan lines of a video are played one by one, but a frame rate of the mode is far lower than that of the interlace mode, thereby resulting in defects such as video discontinuity or motion blur.

In order to increase the video resolution to make the video clearer and to reduce the defects of video discontinuity and video blur, the motion adaptive deinterlacing technology and the motion compensated deinterlacing technology are usually employed, so as to enable an interlace mode video to have increased vertical resolution with respect to the motion video. In recent years, the motion interpolation technology is employed to increase the frame rate, as shown in to FIG. 1, and FIG. 1 is a schematic view of the motion interpolation technology.

Referring to FIG. 1, a video signal 10 has a plurality of frames (such as a (k−1)^{th} frame F^{k-1}, a k^{th} frame F^{k} and a (k+1)^{th} frame F^{k+1}.). The motion interpolation technology may estimate a motion trajectory (that is, a motion vector) of a moving object (for example, a round moving object 110 in FIG. 1) according to the frame F^{k} and the frame F^{k+1}, and then calculate and interpolate new pixel data and an interpolated frame F^{k+0.5}, so as to effectively increase displayed frame fields per second with the vertical resolution being kept, thereby making an action in the video smoother and clearer, preventing a viewer from feeling that the frames are jittering, and reducing the defects of action discontinuity and video blur. For the progressive scan mode having a low frame rate, the technology may be employed to increase the frame rate of an output video signal. For an interlace frame, the technology may also be employed to increase the vertical resolution.

In the motion interpolation technology, in order to make distribution of motion vectors of the same moving object be more consistent, smoothing processing is performed on motion vectors of closing blocks, so as to reduce variations of the motion vectors. However, when the smoothing processing is performed on a video junction of two dynamic regions or edge portions of dynamic and static regions, an error may be incurred to estimation of a motion vector, which instead incurs video defects (such as a halo defect and a zigzag-shaped artificial defect).

In order to solve the above problems, in relevant motion interpolation technologies, generally a plurality of motion vectors is used to capture corresponding pixel data, and the pixels are mixed to form an interpolated frame. However, the method dramatically increases the frequency of capturing frame data, which can only be achieved by using a large frame memory bandwidth. Therefore, many manufacturers are seeking for a motion interpolation technology that can reduce video defects and decrease frequency of accessing frame data.

### SUMMARY OF THE INVENTION

The present invention is directed to a motion vector refining device, which employs spatial and temporal reliability analysis to avoid instability of a motion vector on an edge of a moving object, so as to reduce video defects during motion interpolation and reduce a frequency of accessing frame data.

On the other hand, the present invention is directed to a video refining method for modifying a motion vector, in which spatial and temporal reliability analysis is employed to instability of a motion vector on an edge of a moving object, and an interpolated frame is produced according to a refined motion vector, so as to reduce video defects caused by smoothing processing. That is, according to the present invention, the effect of decreasing video defects can be achieved without accessing a large plurality of pixels. In other words, the frequency of accessing frame data is decreased.

The present invention provides a motion vector refining device, which includes a motion estimation unit, a reliability analysis module and a motion vector mixing module. The motion estimation unit may receive a video signal having a plurality of frames or use historical information (for example, motion vectors of closing frames) previously calculated by the motion estimation unit, so as to estimate many aggregate motion vectors. The aggregate motion vectors includes N target motion vectors, N is a positive integer. The reliability analysis module is coupled to the motion estimation unit, and receives and analyzes a spatial reliability factor and a temporal reliability factor of the N target motion vectors, so as to dynamically estimate and adjust N reliability weight values corresponding to the N target motion vectors. The motion vector mixing module is coupled to the motion estimation unit and the reliability analysis module, and dynamically mixes the target motion vectors and the reliability weight values, so as to produce a refined motion vector.

In other aspects, the present invention provides a video refining method for modifying a motion vector, which includes the following steps: receiving a video signal having many frames to estimate a plurality of aggregate motion vectors, where the aggregate motion vectors include N target motion vectors; analyzing a spatial reliability factor and a temporal reliability factor of the N target motion vectors, so as to dynamically estimate and adjust N reliability weight values corresponding to the N target motion vectors; and using the reliability weight values to dynamically mix the target motion vectors, so as to produce a refined motion vector.

Based on the above, in the embodiments of the present invention, reliability weight values are scored and estimated with respect to selected motion vectors (for example, a motion vector on the same frame and motion vectors on adjacent frames). Mixing is performed by using the motion vectors and the corresponding weight values to produce a new motion vector, so as to avoid instability of the motion vector on an edge of a moving object. During motion interpolation, the single motion vector may be used to select an interpolated pixel, so as to reduce occurring of video defects and decrease a frequency of accessing frame data. On the other hand, reliability of the motion vector may be known according to an estimation result, so as to determine whether a pixel blurring operation is to be performed on the interpolated pixel, thereby reducing video defects.

In order to make the aforementioned features and advantages of the present invention more comprehensible, embodiments are described in detail below with the accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a motion interpolation technology.

FIG. 2 is a block diagram of a motion interpolation apparatus according to an embodiment of the present invention.

FIG. 3A is a schematic view of selecting a target motion vector according to an embodiment.

FIG. 3B is a schematic view of motion blocks MB^{k} (x), MB^{k} (x+a₁) to MB^{k} (x+aₘ) and a motion vector MV^{k} (x) of a K^{th} frame.

FIG. 4 is a block diagram of a reliability analysis module according to an embodiment of the present invention.

FIG. 5 is a block diagram of a reliability analysis module according to an embodiment of the present invention.

FIG. 6 is a block diagram of a spatial reliability analysis unit.

FIG. 7A is a relationship diagram of a spatial variance and a spatial weight value.

FIG. 7B is a relationship diagram of a temporal variance and a temporal weight value.

FIG. 7C is a relationship diagram of a pixel difference value and a block weight value.

FIG. 7D is a relationship diagram of texture complexity and a texture weight value.

FIG. 7E is relationship diagrams of still information, a target motion vector and a still weight value.

FIG. 8 is a block diagram of a motion vector mixing module according to an embodiment of the present invention.

FIG. 9 is a block diagram of a pixel mixing module according to an embodiment of the present invention.

FIG. 10 is a flow chart of a video refining method for modifying a motion vector according to an embodiment of the present invention.

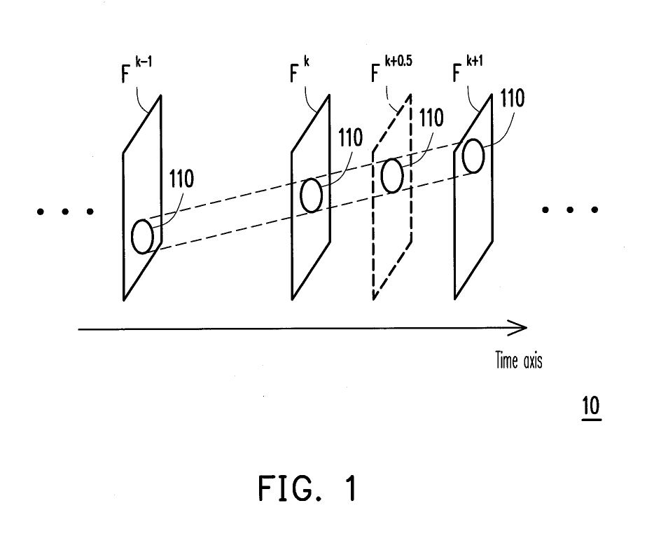

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

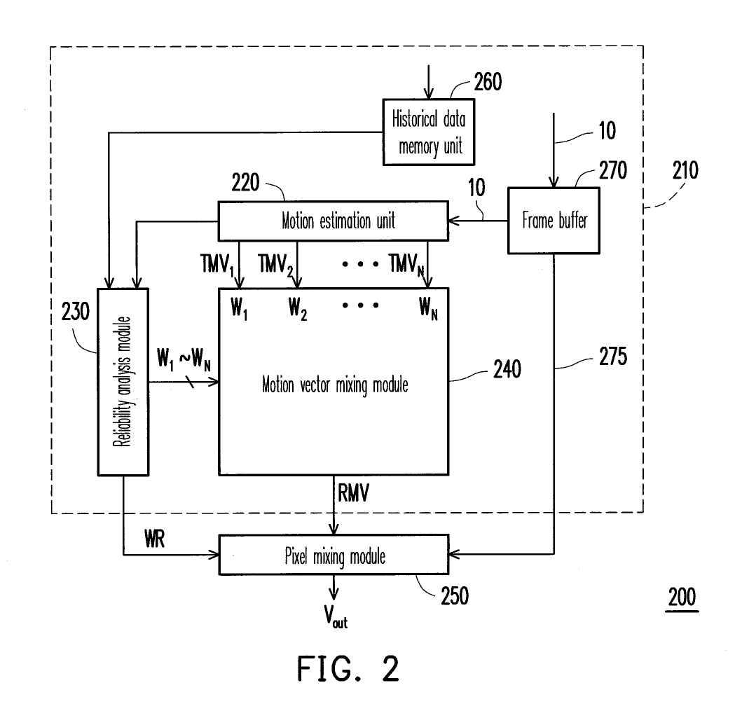

FIG. 2 is a block diagram of a motion interpolation apparatus 200 according to an embodiment of the present invention. Referring to FIG. 2, the motion interpolation apparatus 200 includes a motion vector refining device 210 and a pixel mixing module 250. The motion vector refining device 210 includes a motion estimation unit 220, a reliability analysis module 230, and a motion vector mixing module 240. In the embodiment, the motion interpolation apparatus 200 may also be applied in a motion compensation device or other video processing technologies.

An actuation manner and a hardware architecture of the motion vector refining device 210 are illustrated herein. The motion estimation unit 220 receives a plurality of frames of a video signal 10, so as to estimate a plurality of aggregate motion vectors corresponding to each block in each frame. It should be easy for persons skilled in the art to know relevant implementation and the hardware architecture of the motion estimation unit 220, which are not repeated herein. Further, the motion estimation unit 220 may also use historical information already calculated by the motion estimation unit 220 with respect to different frames at a previous time. The historical information is, for example, previously calculated motion vectors, motion blocks and relevant parameters (for example, a calculated spatial reliability factor and a calculated temporal reliability factor in the following description) of different frames.

The reliability analysis module 230 is coupled to the motion estimation unit 220. The reliability analysis module 230 obtain motion vectors for reference (the motion vectors for reference are called target motion vectors TMV₁-TMV_{N} herein, and N is a positive integer) from the aggregate motion vectors, and use the target motion vectors TMV₁-TMV_{N} and the relevant historical information to analyze a plurality of reliability factors, so as to perform a scoring mechanism (for example, to analyze factors such as spatial reliability, temporal reliability, a pixel difference value of adjacent blocks, texture complexity, and still information), and dynamically estimate and adjust reliability weight values W₁-W_{N} corresponding to the target motion vector TMV₁-TMV_{N}.

Referring to FIG. 2, the motion vector mixing module 240 is coupled to the motion estimation unit 220 and the reliability analysis module 230, and may dynamically mix the target motion vector TMV₁-TMV_{N} for reference by using the reliability weight values W₁-W_{N}, so as to produce a refined motion vector RMV. Therefore, the motion vector refining device 210 may use the scoring mechanism to reduce or even avoid instability of a motion vector on an edge of a moving object.

Further, in the embodiment, the motion vector refining device 210 further includes a frame buffer 270 and a historical data memory unit 260. The frame buffer 270 receives and temporarily stores a plurality of frames in the video signal 10, which are for the motion estimation unit 220 and the pixel mixing module 250 to access and reference. The historical data memory unit 260 may receive and store the pixel difference value, the texture complexity and the still information corresponding to each motion block. The information is provided to the reliability analysis module 230 as a reference for estimation of the reliability weight value. Further, the information may be provided by other video processing devices, such as the motion estimation unit 220 and a texture complexity calculation element.

In the embodiment, the reliability analysis module 230 may further use the reliability weight values W₁-W_{N} to estimate and calculate an analysis result WR. If the value of the analysis result WR is great, it indicates that the refined motion vector RMV is reliable and accurate. In contrast, if the value of the analysis result WR is small, it indicates that the refined motion vector RMV is inaccurate.

Therefore, the pixel mixing module 250 of the motion interpolation apparatus 200 may use the refined motion vector RMV to obtain a corresponding target pixel group and a plurality of adjacent pixel groups close to the target pixel group from a transmission bus 275 of the frame buffer 270, and perform a pixel blurring operation with reference to the value of the analysis result WR, so as to produce an interpolated frame F^{k+0.5} of an output video signal Vout. For example, herein a target pixel is used as the target pixel group, and the pixel mixing module 250 captures, for example, a 16×16 pixel array centering on the target pixel from the frame buffer 270, which is used as the adjacent pixel group, but the present invention is not limited thereto.

When the analysis result WR is greater than a reliability threshold value, it indicates that the refined motion vector RMV is very accurate, so that the pixel mixing module 250 directly outputs the target pixel. On the other hand, when the value of the analysis result WR is smaller than the reliability threshold value and the reliability analysis module 230 is raising the analysis result WR, the pixel mixing module 250 may decrease intensity of the pixel blurring operation, so as to make the output interpolated pixel group be closer to the target pixel. In contrast, when the value of the analysis result WR is smaller than the reliability threshold value and the reliability analysis module 230 is lowering the analysis result WR, the pixel mixing module 250 may increase the intensity of the pixel blurring operation to increase the dependence of the interpolated pixel group on the adjacent pixel group (for example, the 16×16 pixel array is averaged to output a pixel value), so as to reduce the occurring of video defects.

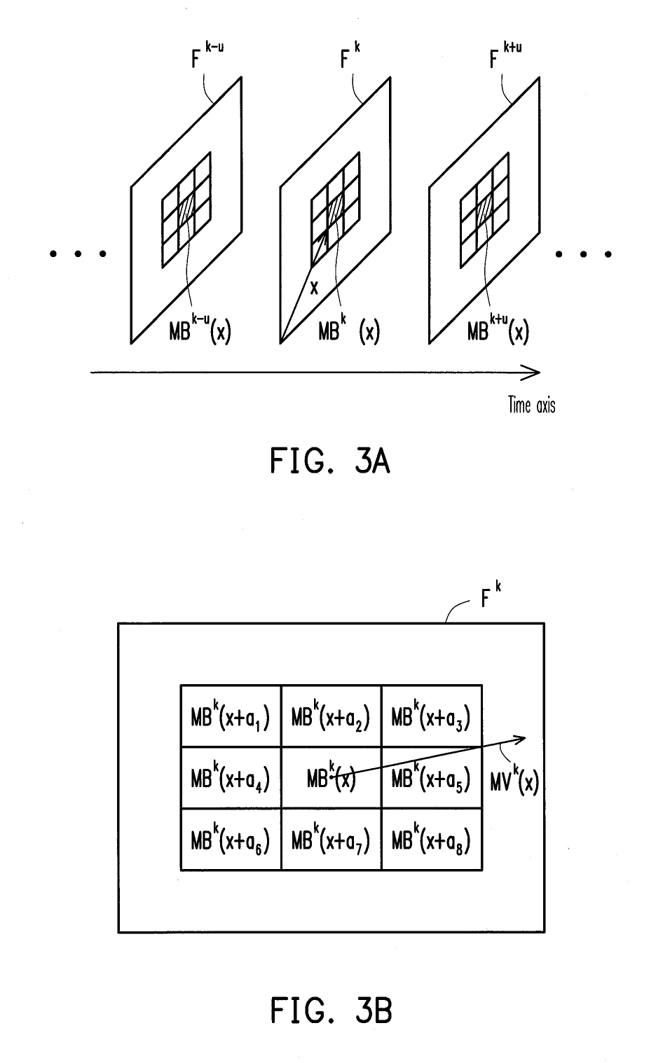

It should be noted that the target motion vector may be selected by a person implementing the embodiment according to design requirements thereof. The target motion vectors may be selected from adjacent motion vectors (called spatially adjacent motion vectors) of the same frame, motion vectors (temporally adjacent motion vectors) in an adjacent frame and in the same or closing position and a zero motion vector MV0. Illustration is provided here through an example. As shown in FIG. 3A and FIG. 3B, FIG. 3A is a schematic view of selecting a target motion vector according to the embodiment, and FIG. 3B is a schematic view of motion blocks MB^{k} (x), MB^{k} (x+a₁) to MB^{k} (x+aₘ) and a motion vector MV^{k} (x) of a K^{th} frame, where k, m and u are positive integers, x is a position vector, and a₁-aₘ are offset vectors of the position vector x (in the embodiment, illustration is provided by taking an example in which m is equal to 8, but the present invention is not limited thereto).

The parameter u represents an offset of adjacent frames on a time axis. The embodiment of the present invention does not limit the number of frames between adjacent frames. When the frame rate is low, a time difference between adjacent frames is too big, which causes the temporal reliability to be inaccurate. A person implementing the embodiment may adjust the parameter u to decrease the number of frames between the adjacent frame for reference and the K^{th} frame, so as to improve the accuracy of a temporal reliability weight value. For ease of illustration, in the embodiment, the parameter u is set to 1 in FIG. 3A, but the present invention is not limited thereto.

Referring to FIG. 3A and FIG. 3B, MB^{k} (x) represents the motion block of the position vector x in the K^{th} frame F^{k}, and MV^{k} (x) represents the motion vector of the position vector x in the K^{th} frame F^{k}. Accordingly, MB^{k-1} (x) represents the motion block of the position vector x in the (K−1)^{th} frame F^{k}, and MV^{k-1} (x) represents the motion vector corresponding to MB^{k-1} (x). MB^{k} (x+a₁) to MB^{k} (x+aₘ) are motion blocks adjacent to MB^{k} (x). MV^{k} (x+a₁) to MV^{k} (x+aₘ) are motion vectors corresponding to the motion blocks MB^{k} (x+a₁) to MB^{k} (x+aₘ) respectively, so that MV^{k} (x+a₁)−MV^{k} (x+aₘ) may also be called spatially adjacent motion vectors of MV^{k} (x).

On the other hand, b₁-bₙ and c₁-cₚ are also offset vectors of the position vector x, and n and p are positive integers. Therefore, MV^{k+u} (x+b₁) to MV^{k+u} (x+bₙ) of a (k+u)^{th} frame are spatially adjacent motion vectors of MV^{k+u} (x), MV^{k+u} (x+c₁) to MV^{k-u} (x+cₚ) of a (k−u)^{th} frame are spatially adjacent motion vectors of MV^{k-u}(x), and MV^{k+u} (x) and MV^{k-u} (x) are adjacent frames of the MV^{k} (x), so that MV^{k+u} (x+b₁) to MV^{k+u} (x+bₙ) and MV^{k-u} (x+c₁) to MV^{k-u} (x+cₚ) are temporally adjacent motion vectors of MV^{k} (x). Herein, MV^{K} (x), MV^{K} (x+a₁) to MV^{K} (x+aₘ), MV^{K+h} (x+b₁)−MV^{K+u} (x+bₙ), and MV^{K-u} (x+c₁) to MV^{K-u} (x+cₚ) are all defined as target motion vectors TMV₁ to TMV_{N}, where N is equal to (1+m+n+p). In the embodiment, the motion vectors, for example, MV^{k+u} (x+b₁) to MV^{k+u} (x+bₙ) and MV^{k-u} (x+c₁) to MV^{k-u} (x+cₚ) may all be calculated by the motion estimation unit 220 at a previous time, so that the motion estimation unit 220 may temporarily store the motion vectors in advance, which are used repeatedly in following motion estimation, saving the need of calculating the same motion vectors and relevant historical information repeatedly each time.

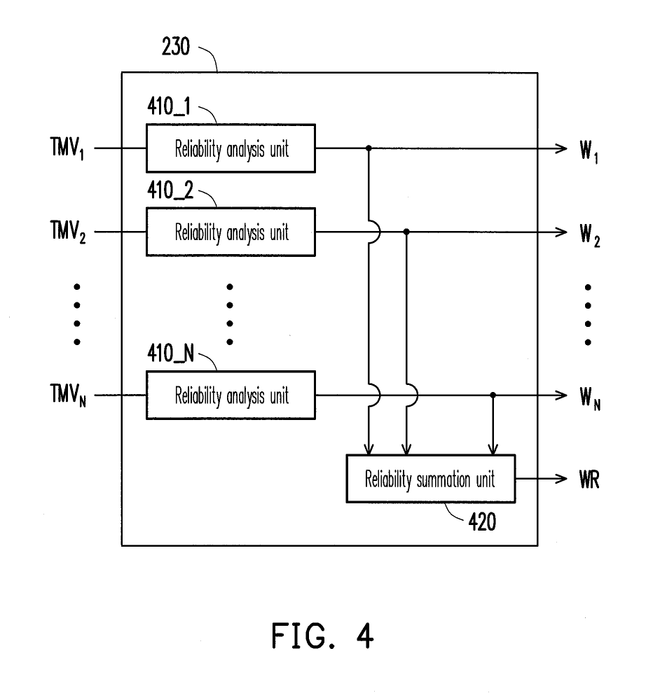

Actuation principles and a functional architecture of the reliability analysis module 230 are illustrated herein in detail. FIG. 4 is a block diagram of the reliability analysis module 230 according to an embodiment of the present invention. Referring to FIG. 4, the reliability analysis module 230 has reliability analysis units 410_1-410_N and a reliability summation unit 420. The reliability analysis units 410_1-410_N correspond to the target motion vectors TMV₁ to TMV_{N} respectively, so as to estimate reliability weight value W₁-W_{N} according to a plurality of reliability factors. In the embodiment, the reliability summation unit 420 may add the reliability weight values W₁-W_{N} up, so as to calculate an analysis result WR of this time. In other embodiments, the reliability summation unit 420 may select a greatest value among the reliability weight values W₁-W_{N}, which is output as the analysis result WR. A person implementing the embodiment may calculate the analysis result WR according to design requirements thereof, so that the present invention is not limited thereto.

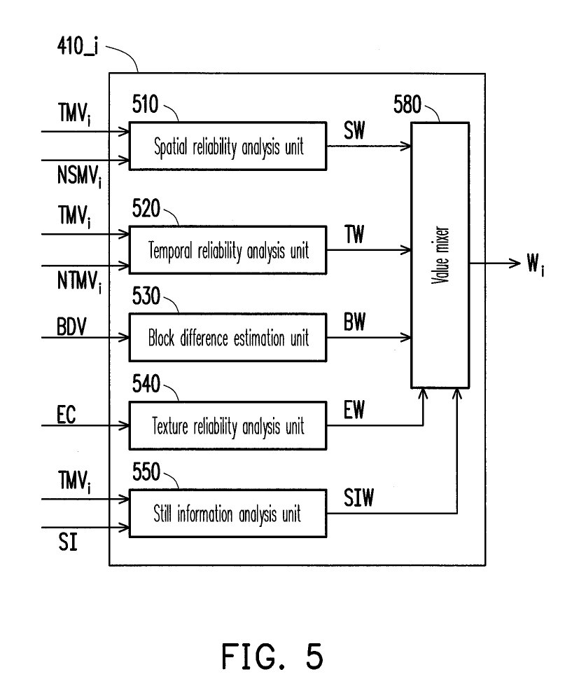

FIG. 5 is a block diagram of a reliability analysis unit 410_{—}i according to an embodiment of the present invention, where i is a positive integer and 1≦i≦N. For ease of illustrating the following embodiments, herein the target motion vector TMVᵢ is defined to be a motion vector MV^{L} (y) in an L^{th} frame and in a position being y, y is a position vector, L and i are positive integers, 1≦i≦N, and MB^{L} (y) is a motion block corresponding to the motion vector MV^{L} (y). Therefore, MV^{L} (y+a₁) to MV^{L} (y+aₘ) represent spatially adjacent motion vectors NSMVᵢ of the i^{th} target motion vector TMVᵢ (that is, MV^{L} (y)). MV^{L+1} (x+b₁) to MV^{L+1} (x+bₙ) and MV^{L-1} (x+c₁) to MV^{L-1} (x+cₚ) represent temporally adjacent motion vectors NTMVᵢ of the i^{th} target motion vector TMVᵢ. Persons skilled in the art may deduce definitions and physical meanings thereof of the spatially adjacent motion vectors NSMVᵢ and the temporally adjacent motion vectors TSMVᵢ according to the illustration, which are not repeated herein.

The reliability analysis unit 410_{—}i includes a plurality of scoring mechanisms. In the embodiment, a spatial reliability analysis unit 510 and a temporal reliability analysis unit 520 are the main scoring mechanisms, in combination with scoring mechanisms related to historical information, such as a block difference estimation unit 530, a texture reliability analysis unit 540 and a still information analysis unit 550, so as to produce many weight values. Herein, the weight value produced by each of the scoring mechanisms is called an aggregation weight value, for example, a spatial weight value SW, a temporal weight value TW, a block weight value BW, a texture weight value EW and a still weight value DW, and an estimation manner of the weight values are illustrated in the following description. The reliability analysis unit 410_{—}i uses a value mixer 580 to perform mixing calculation on the aggregation weight values, so as to produce a reliability weight value Wᵢ corresponding to the target motion vector TMVᵢ.

The scoring mechanism of the spatial reliability analysis unit 510 is illustrated below. The spatial reliability analysis unit 510 uses the target motion vector TMVᵢ and the spatially adjacent motion vectors NSMVᵢ thereof to calculate a spatial variance SVar, and uses the spatial variance SVar to estimate the spatial weight value SW.

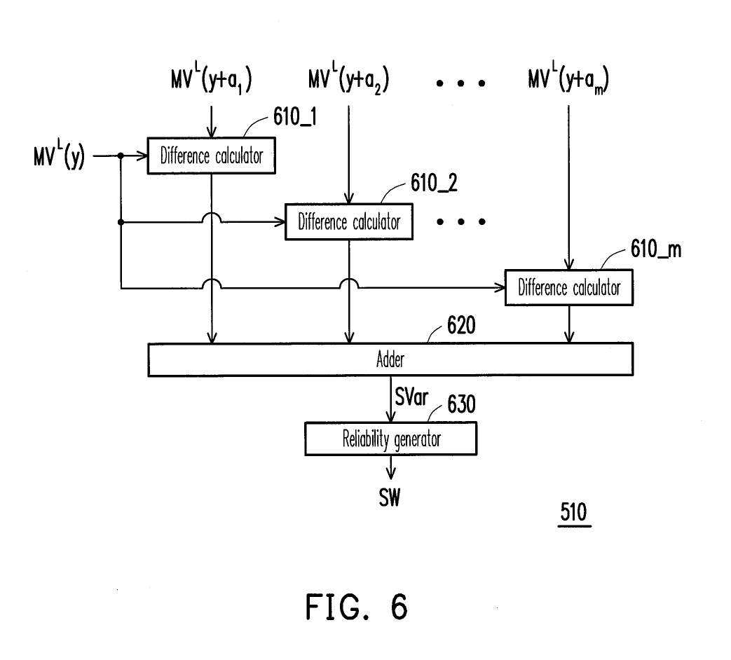

Specifically, a hardware architecture of the spatial reliability analysis unit 510 is shown in FIG. 6, and FIG. 6 is a block diagram of the spatial reliability analysis unit 510. In the embodiment, the spatial reliability analysis unit 510 includes difference calculators 610_1-610_{—}m, an adder 620, and a reliability generator 630. The difference calculators 610_1-610_{—}m calculate a value difference between the target motion vector TMVᵢ (that is, MV^{L}(y)) and the spatially adjacent motion vectors NSMVᵢ (MV^{L} (y+a₁) to MV^{L} (y+aₘ)) thereof respectively. The adder 620 adds the value differences up, so as to calculate the spatial variance SVar. The reliability generator 630 uses the spatial variance SVar to estimate the spatial weight value SW.

In the embodiment, the spatial variance SVar may be calculated by two methods. In one method, the difference calculators 610_1-610_{—}m calculate the value difference between the motion vectors, which is the square of the difference between the motion vectors, as shown in an equation (1):

$$SVar = \{ \begin{matrix}{[ {MV}^{L} ( y + {a}_{1} ) - {MV}^{L} ( y ) ]}^{2} + {[ {MV}^{L} ( y + {a}_{2} ) - {MV}^{L} ( y ) ]}^{2} + … + \\ {[ {MV}^{L} ( y + {a}_{m} ) - {MV}^{L} ( y ) ]}^{2}\end{matrix} \} . \qquad ( 1 )$$

In the other method of calculating the spatial variance SVar, the difference calculators 610_1-610_{—}m calculate the value difference between the motion vectors, which is the absolute value of the difference between the motion vectors, as shown in an equation (2):

$$SVar = \{ \begin{matrix}\vert {MV}^{L} ( y + {a}_{1} ) - {MV}^{L} ( y ) \vert + \vert {MV}^{L} ( y + {a}_{2} ) - {MV}^{L} ( y ) \vert + … + \\ \vert {MV}^{L} ( y + {a}_{m} ) - {MV}^{L} ( y ) \vert\end{matrix} \} . \qquad ( 2 )$$

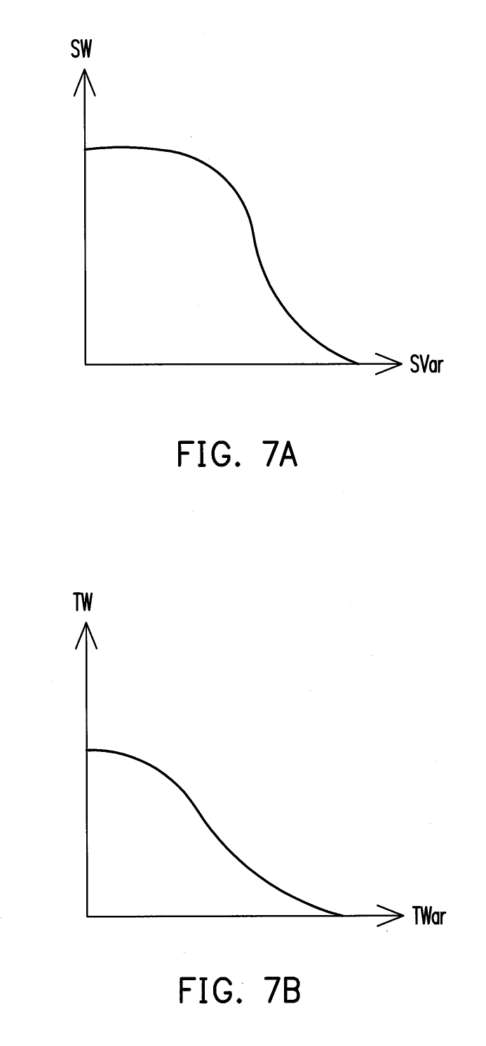

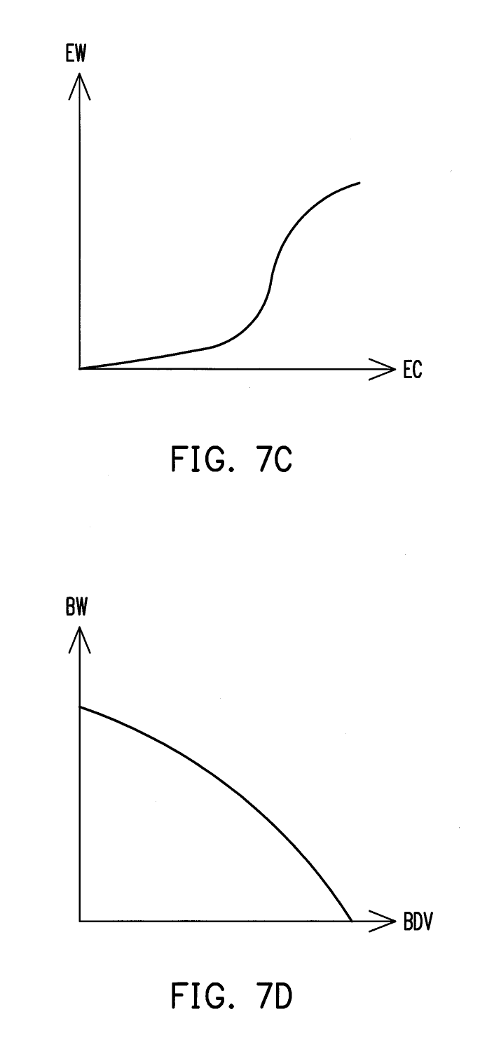

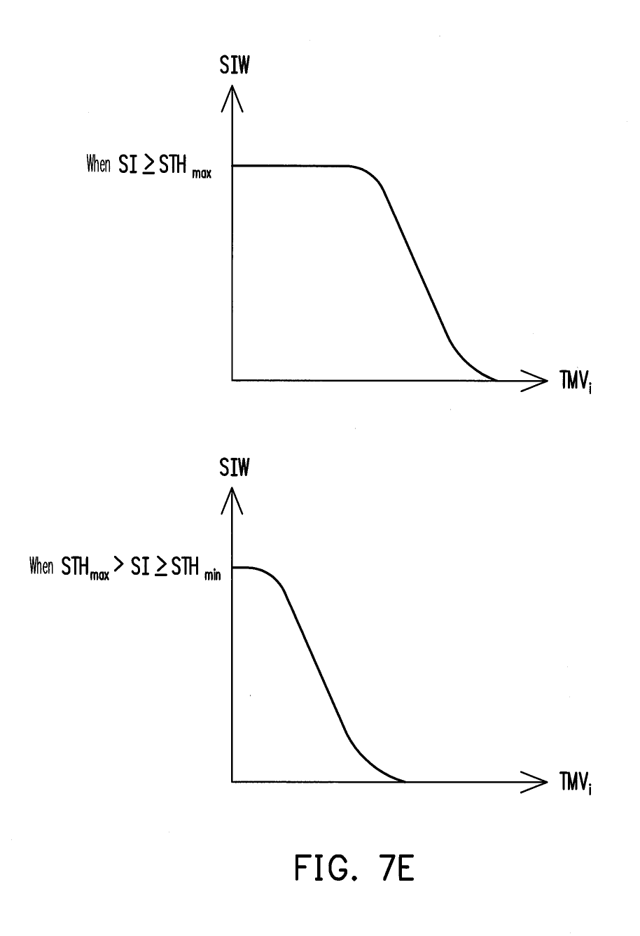

Then, the reliability generator 630 uses the spatial variance SVar to estimate the spatial weight value SW by looking into a table or by other manners. In the embodiment, the reliability generator 630 performs the estimation by using a relationship diagram of the spatial variance SVar and the spatial weight value SW shown by FIG. 7A. According to FIG. 7A, when the spatial variance SVar is small, it indicates that the target motion vector TMVᵢ may be in a large moving object, so that the adopted target motion vector TMVᵢ is accurate, and the spatial weight value SW shall be greater. In contrast, when the spatial variance SVar is great, it indicates that differences of adjacent motion vectors are all too great, the target motion vector TMVᵢ may be in an edge region of the moving object, and the spatial weight value SW shall be smaller.

Compared with the above, the hardware architecture of the temporal reliability analysis unit 520 is similar to that of the spatial reliability analysis unit 510, and a difference is as follows. The temporal reliability analysis unit 520 uses the target motion vector TMVᵢ (that is, MV^{L}(y)) and the temporally adjacent motion vectors NTMVᵢ (that is, MV^{L+1} (x+b₁) to MV^{L+1} (x+bₙ) and MV^{L-1} (x+c₁) to MV^{L-1} (x+cₚ)) to calculate a temporal variance TVar, and estimates the temporal weight value TW by using the temporal variance TVar. The temporal reliability analysis unit 520 may perform the estimation by using by using a relationship diagram of the temporal variance TVar and the temporal weight value TW shown by FIG. 7B, which is not repeated herein.

On the other hand, referring to FIG. 5, the scoring mechanisms, which are related to the historical information and are the block difference estimation unit 530, the texture reliability analysis unit 540 and the still information analysis unit 550 are illustrated herein. The scoring mechanisms perform estimation according to the historical information (for example, a pixel difference value, texture complexity or still information corresponding to each motion block) stored in the historical data memory unit 260 of FIG. 2. A person implementing the embodiment may adjust the scoring mechanisms according to design requirements thereof and relevant information capable of being provided in the video processing technologies. Actuation principles of the scoring mechanisms are illustrated below in sequence.

The block difference estimation unit 530 obtains the target motion vector TMVᵢ and a corresponding pixel difference value BDV thereof from the historical data memory unit 260 of FIG. 2, and uses a relationship diagram of the pixel difference value BDV and the block weight value BW shown by FIG. 7C to estimate the block weight value BW, so as to estimate a block difference factor. The pixel difference value is obtained by calculating a pixel difference between the i^{th} motion block MB^{L} (y) corresponding to the i^{th} target motion vector TMVᵢ and adjacent motion blocks thereof, so as to determine whether the motion block is similar to the adjacent motion blocks. Therefore, as shown in FIG. 7C, when the pixel difference value BDV is great, it indicates that the motion block MB^{L} (y) is not similar to any adjacent block, and the target motion vector TMVᵢ may be inaccurate, so that the block difference estimation unit 530 decreases the block weight value BW. Further, when the pixel difference value BDV is small, it indicates that the motion block MB^{L} (y) and the adjacent block may belong to the same moving object, and the target motion vector TMVᵢ shall be accurate, so that the block difference estimation unit 530 increases the block weight value BW.

The texture reliability analysis unit 540 obtains texture complexity EC of the motion block MB^{L} (y) from the historical data memory unit 260, and estimates the texture weight value EW by using a relationship diagram of the texture complexity EC and the texture weight value EW shown by FIG. 7D, so as to estimate a texture factor. The texture complexity EC is used to define texture distribution density of the motion block MB^{L} (y), so as to judge whether the motion block MB^{L} (y) includes texture information greater than a certain extent. The texture complexity EC may be obtained by using a high pass filter to perform filter processing on the motion block motion block MB^{L} (y), actuation principles of which are easy to be known by persons skilled in the art and are not repeated herein.

The reason for employing the texture factor is as follows. In the motion estimation technologies, when the texture complexity (the texture distribution density) of the motion block MB^{L} (y) is high, the corresponding motion vector MV^{L} (y) thereof is accurate. Therefore, as shown in FIG. 7D, when the texture complexity EC is great, the texture reliability analysis unit 540 increases the texture weight value EW. In contrast, when the texture complexity EC is small, the texture reliability analysis unit 540 decreases the texture weight value EW.

Further, the still information analysis unit 550 obtains the target motion vector TMVᵢ and corresponding still information SI thereof from the historical data memory unit 260, and uses relationship diagrams of the still information SI, the target motion vector TMVᵢ and a still weight value SIW of FIG. 7E to estimate the still weight value SIW, so as to estimate a still block factor. The still information may be calculated according to motion blocks in adjacent frames and in the same position. For example, the still information is obtained by calculating pixel differences between MB^{L} (y) and MB^{L+1} (y) to MB^{L-1} (y). Therefore, the still information SI may indicate whether motion blocks (for example, MB^{L} (y) and MB^{L+1} (y) to MB^{L-1} (y)) in adjacent frames and in the same position vary with respect to the pixels, which is the pixel differences between the motion blocks in adjacent frames and in the same position, so as to determine whether the motion blocks are temporally still.

For example, referring to FIG. 7E, when the still information SI is greater than or equal to a maximum still threshold value STHₘₐₓ, it indicates that MB^{L} (y) may be in a still object or a large-area moving object, and the still information analysis unit 550 uses the upper relationship diagram of FIG. 7E to select the still weight value SIW according to the target motion vector TMVᵢ. When the value of the target motion vector TMVᵢ is great, the still weight value SIW is great.

When the still information SI is smaller than the maximum still threshold value STHₘₐₓ and is greater than or equal to a minimum still threshold value STHₘᵢₙ, the still information analysis unit 550 uses the lower relationship diagram of FIG. 7E to select the still weight value SIW according to the target motion vector TMVᵢ. According to the diagrams in FIG. 7E, the range where the target motion vector TMVᵢ has the great still weight value SIW shrinks as the still information SI becomes smaller. When the still information SI is smaller than the minimum still threshold value STHₘᵢₙ, the still information analysis unit 550 sets the still weight value SIW to “0”, so as to indicate that the target motion vector TMVᵢ is completely unreliable in the still block factor.

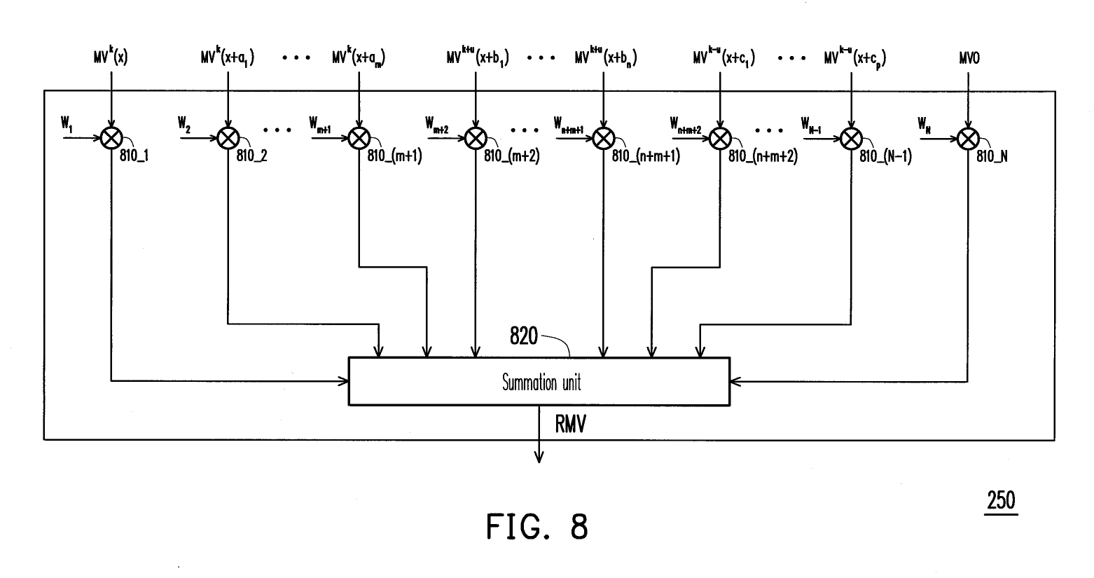

When the above functions are implemented, the motion vector mixing module 240 may have two implementation manners. One is shown in FIG. 8, and FIG. 8 is a block diagram of the motion vector mixing module 240 according to an embodiment of the present invention. The motion vector mixing module 240 includes N multipliers 810_1-810_N and a summation unit 820. The i^{th} multiplier 810_{—}i multiplies the i^{th} target motion vector TMVᵢ by a corresponding reliability weight value Wᵢ thereof. The summation unit 820 adds up results of multiplication, so as to produce the refined motion vector RMV.

In the other implementation manner, a multiplexer is used as the motion vector mixing module 240, and may select a target motion vector TMVᵢ corresponding to a greatest reliability weight value Wᵢ and use the target motion vector TMVᵢ as the output refined motion vector RMV, which also complies with the spirit of the embodiment.

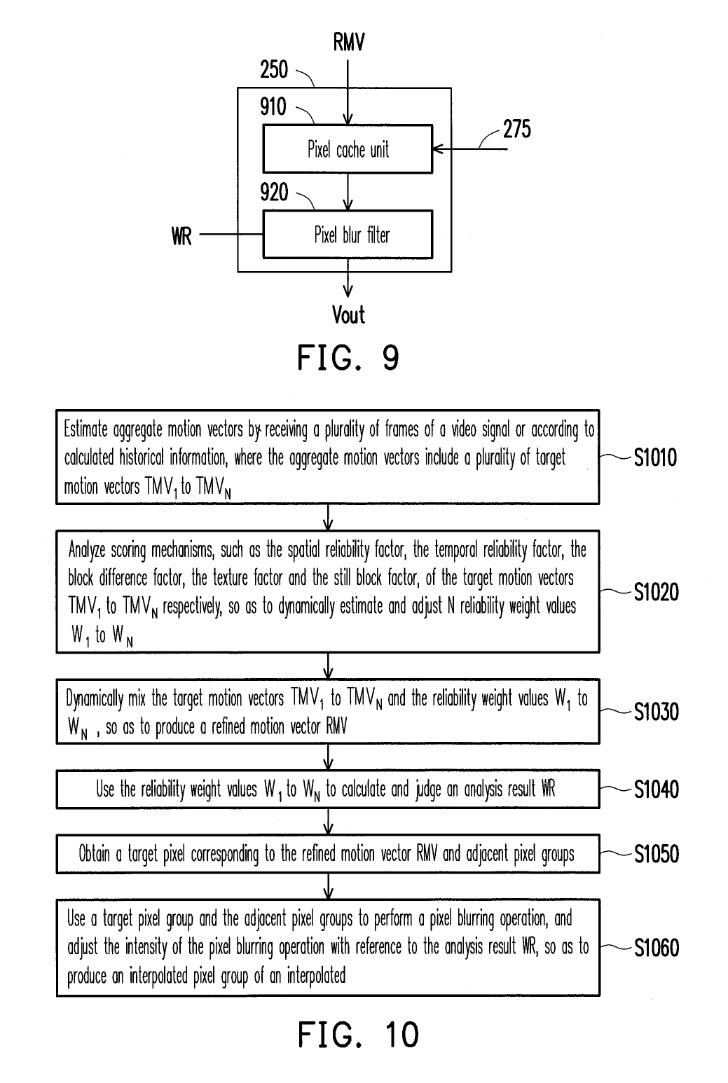

Further, during implementation the pixel mixing module 250 may be as what is shown in FIG. 9, and FIG. 9 is a block diagram of the pixel mixing module 250 according to an embodiment of the present invention. Referring to FIG. 9, the pixel mixing module 250 includes a pixel cache unit 910 and a pixel blur filter 920. The pixel cache unit 910 receives a target pixel corresponding to the refined motion vector RMV and a closing target pixel group from the transmission bus 275 of the frame buffer 270 of FIG. 2. The pixel blur filter 920 coupled to the pixel cache unit 910 uses the target pixel group and the adjacent pixel groups to perform the pixel blurring operation, so as to produce an interpolated pixel group of an interpolated frame in an output video signal Vout. The pixel blur filter 920 adjusts the intensity of the pixel blurring operation with reference to the analysis result WR. The above embodiments may be referred to for other actuation manners of the embodiment, which are not repeated herein.

On the other hand, an embodiment of the present invention provides a video refining method for modifying a motion vector. FIG. 10 is a flow chart of a video refining method for modifying a motion vector according to an embodiment of the present invention. Referring to FIG. 2 and FIG. 10, in Step S1010, the motion estimation unit 220 estimates aggregate motion vectors by receiving a plurality of frames of a video signal 10 or according to calculated historical information. The aggregate motion vectors include a plurality of target motion vectors TMV₁-TMV_{N}. Then, in Step S1020, the reliability analysis module 230 analyzes scoring mechanisms, such as the spatial reliability factor, the temporal reliability factor, the block difference factor, the texture factor and the still block factor, of the target motion vectors TMV₁-TMV_{N} respectively, so as to dynamically estimate and adjust N reliability weight values W₁-W_{N} corresponding to the target motion vectors TMV₁-TMV_{N}.

In Step S1030, the motion vector mixing module 240 dynamically mixes the target motion vectors TMV₁-TMV_{N} and the reliability weight values W₁-W_{N}, so as to produce a refined motion vector RMV. Then, in Step S1040, the reliability analysis module 230 uses the reliability weight values W₁-W_{N} to calculate and judge an analysis result WR. The pixel mixing module 250 obtains a target pixel corresponding to the refined motion vector RMV and adjacent pixel groups in Step S1050. In Step S1060, the pixel mixing module 250 uses a target pixel group, the adjacent pixel groups and the analysis result WR to perform a pixel blurring operation, and the intensity of the pixel blurring operation is adjusted according to the analysis result WR, so as to produce an interpolated pixel group of an interpolated frame in an output video signal. Other detailed steps of the embodiment are included in the above embodiments, and therefore are not repeated herein.

In view of the above, in the embodiments of the present invention, reliability weight values are scored and estimated with respect to selected motion vectors (for example, a motion vector on the same frame and motion vectors on adjacent frames). Mixing is performed by using the motion vectors and the corresponding weight values to produce a new motion vector, so as to avoid instability of the motion vector on an edge of a moving object. During motion interpolation, the single motion vector may be used to select an interpolated pixel, so as to reduce occurring of video defects and decrease a frequency of accessing frame data. On the other hand, the motion interpolation apparatus may further know reliability of the motion vector according to an estimation result, so as to determine whether a pixel blurring operation is to be performed on the interpolated pixel, thereby reducing video defects.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A motion vector refining device, comprising:
a motion estimation unit, used for estimating a plurality of aggregate motion vectors by receiving a plurality of frames of a video signal or calculated historical information, wherein the aggregate motion vectors comprise N target motion vectors, and N is a positive integer;
a reliability analysis module, coupled to the motion estimation unit and used for analyzing a spatial reliability factor and a temporal reliability factor of the N target motion vectors, so as to dynamically estimate and adjust N reliability weight values corresponding to the N target motion vectors; and
a motion vector mixing module, coupled to the motion estimation unit and the reliability analysis module, and using the reliability weight values to dynamically mix the target motion vectors to produce a refined motion vector.

2. The motion vector refining device according to claim 1, wherein the aggregate motion vectors comprises MV^{k} (x), MV^{k} (x+a₁) to MV^{k} (x+aₘ), MV^{k+u} (x+b₁) to MV^{k+u} (x+bₙ), and MV^{k-u} (x+c₁) to MV^{k-u} (x+cₚ), MV^{k} (x) is a motion vector of a position x in a K^{th} frame, u is an offset of a frame on a time axis, x is position vector; a₁-aₘ, b₁-bₙ and c₁-cₙ are a plurality of offset vectors of the position vector; MV^{k} (x), MV^{k} (x+a₁) to MV^{k} (x+aₘ), MV^{k+u} (x+b₁) to MV^{k+u} (x+bₙ), and MV^{k-u} (x+c₁) to MV^{k-u} (x+cₚ) are defined to be the N target motion vector; k, u, m, n and p are positive integers, and N=(1+m+n+p).

3. The motion vector refining device according to claim 1, wherein the reliability analysis module comprises N reliability analysis units, i is a positive integer, and 1≦i≦N,
the i^{th} reliability analysis unit comprises:
a spatial reliability analysis unit, for calculating a spatial variance between the i^{th} target motion vector and a plurality of spatially adjacent motion vectors close to the i^{th} target motion vector to analyze the spatial reliability factor, and estimating a spatial weight value;
a temporal reliability analysis unit, for calculating a temporal variance between the i^{th} target motion vector and a plurality of temporally adjacent motion vectors close to the i^{th} target motion vector to analyze the temporal reliability factor, and estimating a temporal weight value; and
a value mixer, coupled to the spatial reliability analysis unit and the temporal reliability analysis unit, and for performing mixing calculation on a plurality of aggregation weight values or selecting one of the aggregation weight values to output the i^{th} reliability weight value, wherein the aggregation weight values comprise the spatial weight value and the temporal weight value.

4. The motion vector refining device according to claim 3, further comprising:
a historical data memory unit, for receiving and storing a pixel difference value, texture complexity or still information of the i^{th} motion block corresponding to the i^{th} target motion vector, wherein the pixel difference value is calculated by the motion estimation unit, the texture complexity defines texture distribution density of the i^{th} target motion vector, and the still information is obtained by calculating a pixel difference between i^{th} motion blocks in adjacent frames and in the same position.

5. The motion vector refining device according to claim 4, wherein the i^{th} reliability analysis unit further comprises:
a block difference estimation unit, for obtaining the pixel difference value to analyze a block difference factor, so as to estimate a block weight value, wherein when the pixel difference value is great, the block weight value is lowered; when the pixel difference value is small, the block weight value is raised; and the aggregation weight values further comprise the block weight value.

6. The motion vector refining device according to claim 4, wherein the i^{th} reliability analysis unit further comprises:
a texture reliability analysis unit, for obtaining the texture complexity to analyze a texture factor, so as to estimate a texture weight value, wherein when the texture complexity is great, the texture weight value is raised; when the texture complexity is small, the texture weight value is lowered; and the aggregation weight values further comprise the texture weight value.

7. The motion vector refining device according to claim 4, wherein the i^{th} reliability analysis unit further comprises:
a still information analysis unit, for obtaining the still information to analyze a still block factor, so as to estimate a still weight value; wherein when the still information is greater than a minimum still threshold value, the still information analysis unit selects the still weight value according to the i^{th} target motion vector; when the still information is smaller than the minimum still threshold value, the still weight value is zero; and the aggregation weight values further comprise the still weight value.

8. The motion vector refining device according to claim 1, wherein the target motion vectors further comprise a zero motion vector.

9. The motion vector refining device according to claim 1, wherein the motion vector mixing module comprises:
N multipliers, wherein the i^{th} multiplier multiplies the i^{th} target motion vector by the i^{th} reliability weight value, so as to produce an i^{th} weight motion vector; and
a summation unit, for adding up N weighted motion vectors to produce the refined motion vector.

10. The motion vector refining device according to claim 1, wherein the motion vector mixing module comprises:
a multiplexer, for selecting and outputting the i^{th} target motion vector corresponding to the i^{th} reliability weight value being the greatest, which is used as the refined motion vector.

11. The motion vector refining device according to claim 1, further comprising:
a pixel mixing module, coupled to the reliability analysis module, and for receiving a target pixel group corresponding to the refined motion vector to perform a pixel blurring operation, so as to produce an interpolated pixel group of an interpolated frame, and for adjusting intensity of the pixel blurring operation with reference to an analysis result.

12. The motion vector refining device according to claim 11, wherein the pixel mixing module comprises:
a pixel cache unit, for receiving a target pixel group corresponding to the refined motion vector and a plurality of adjacent pixel groups adjacent to the target pixel group; and
a pixel blur filter, coupled to the pixel cache unit, and for using the target pixel group and the adjacent pixel groups to perform the pixel blurring operation to produce the interpolated pixel group, and adjusting the intensity of the pixel blurring operation with reference to the analysis result.

13. The motion vector refining device according to claim 11, wherein the reliability analysis module uses the reliability weight values to calculate an analysis result; when the analysis result is greater than a reliability threshold value, the pixel mixing module outputs the target pixel group being a refined pixel group.

14. The motion vector refining device according to claim 13, wherein when the analysis result is smaller than the reliability threshold value and the when the reliability analysis module raises the analysis result, the pixel mixing module decreases an effect of the pixel blurring operation, and
when the analysis result is smaller than the reliability threshold value and the reliability analysis module lowers the analysis result, the pixel mixing module enhance the effect of the pixel blurring operation.

15. The motion vector refining device according to claim 11, wherein the reliability analysis module further comprises:
a reliability summation unit, for adding up the N reliability weight values to produce an analysis result.

16. A video refining method for modifying a motion vector, comprising:
estimating a plurality of aggregate motion vectors by receiving a plurality of frames of a video signal or according to calculated historical information, wherein the aggregate motion vectors comprise N target motion vectors, and N is a positive integer;
analyzing a spatial reliability factor and a temporal reliability factor of the N target motion vectors, so as to dynamically estimate and adjust N reliability weight values corresponding to the N target motion vectors; and
dynamically mixing the target motion vectors and the reliability weight values to produce a refined motion vector.

17. The video refining method according to claim 16, further comprising:
using the N reliability weight values to calculate an analysis result;
obtaining a target pixel group corresponding to the refined motion vector and a plurality of adjacent pixel groups adjacent to the target pixel group; and
using the target pixel group and the adjacent pixel groups to perform a pixel blurring operation, so as to produce a refined pixel group of a refined video signal, and adjust intensity of the pixel blurring operation with reference to the analysis result.

18. The video refining method according to claim 17, wherein the using the N reliability weight values to calculate and judge the analysis result comprises the following step:
adding up the N reliability weight values to produce the analysis result.

19. The video refining method according to claim 17, wherein the adjusting the intensity of the pixel blurring operation with reference to the analysis result comprises the following step:
when the analysis result is greater than a reliability threshold value, outputting the target pixel group being the refined pixel group.

20. The video refining method according to claim 17, wherein the adjusting the intensity of the pixel blurring operation with reference to the analysis result further comprises the following steps:
when the analysis result is smaller than the reliability threshold value and the reliability analysis module raises the analysis result, decreasing an effect of the pixel blurring operation; and
when the analysis result is smaller than the reliability threshold value and the reliability analysis module lowers the analysis result, enhancing the effect of the pixel blurring operation.

21. The video refining method according to claim 16, wherein i is a positive integer, 1≦i≦N, and the dynamically estimating and adjusting the i^{th} reliability weight value comprises the following steps:
calculating a spatial variance between the i^{th} target motion vector and a plurality of spatially adjacent motion vectors close to the i^{th} target motion vector to analyze the spatial reliability factor, and estimating a spatial weight value;
calculating a temporal variance between the i^{th} target motion vector and a plurality of temporally adjacent motion vectors close to the i^{th} target motion vector to analyze the temporal reliability factor, and estimating a temporal weight value; and
performing mixing calculation on a plurality of aggregation weight values or selecting one of the aggregation weight values, so as to output the i^{th} reliability weight value, wherein the aggregation weight values comprise the temporal weight value and the temporal weight value.

22. The video refining method according to claim 21, further comprising:
receiving and storing a pixel difference value, texture complexity or still information of the i^{th} motion block corresponding to the i^{th} target motion vector, wherein the pixel difference value is calculated by a motion estimation unit, the texture complexity defines texture distribution density of the i^{th} target motion vector, and the still information is obtained by calculating a pixel difference between i^{th} motion blocks in adjacent frames and in the same position.

23. The video refining method according to claim 22, wherein the dynamically estimating and adjusting the i^{th} reliability weight value further comprises the following steps:
obtaining the pixel difference value to analyze a block difference factor, so as to estimate a block weight value, wherein the aggregation weight values further comprise the block weight value;
when the pixel difference value is great, lowering the block weight value; and
when the pixel difference value is small, raising the block weight value.

24. The video refining method according to claim 22, wherein the dynamically estimating and adjusting the i^{th} reliability weight value further comprises the following steps:
obtaining the texture complexity to analyze a texture factor, so as to estimate a texture weight value, wherein the aggregation weight values further comprise the texture weight value;
when the texture complexity is great, raising the texture weight value; and
when the texture complexity is small, lowering the texture weight value.

25. The video refining method according to claim 22, wherein the dynamically estimating and adjusting the i^{th} reliability weight value further comprises the following steps:
obtaining the still information to analyze a still block factor, so as to estimate a still weight value, wherein the aggregation weight values further comprise the still weight value;
when the still information is greater than a minimum still threshold value, selecting the still weight value according to the i^{th} target motion vector; and
when the still information is smaller than the minimum still threshold value, setting the still weight value to zero.

26. The video refining method according to claim 16, wherein the generating the refined motion vector comprises the following steps:
multiplying the i^{th} target motion vector by the i^{th} reliability weight value, so as to produce an i^{th} weight motion vector; and
adding up N weighted motion vectors to produce the refined motion vector.

27. The video refining method according to claim 16, wherein the generating the refined motion vector comprises the following steps:
selecting and outputting the i^{th} target motion vector corresponding to the i^{th} reliability weight value being the greatest, which is used as the refined motion vector.
